(19) United States
(12) Patent Application Publication
(10) Pub. No.: US 2008/0084907 A1
(43) Pub. Date: Apr. 10, 2008

(54) Cushioned Lifting Apparatus and Method of Lifting Carbon Based Electrodes

(76) Inventors: David Arthur Lehr, Franklin, TN (US); Jeffrey Clark Williams, Columbia, TN (US); Thomas David Schiller, Franklin, TN (US)

Correspondence Address: WADDEY & PATTERSON, P.C., 1600 DIVISION STREET, SUITE 500, NASHVILLE, TN, 37203, US

(21) Appl. No.: 11/539,558

(22) Filed: Oct. 6, 2006

(51) Int. Cl. H05B 3/60

(52) U.S. Cl. 373/52

(57) ABSTRACT

A lifting apparatus for transporting a carbon based electrode wherein the electrode includes a threaded male end. The apparatus comprises a casing having a top end and a bottom end, a top plate operatively attached to the top end, at least one energy absorbing element positioned between the top plate and the top end, and an attachment element operatively engaging the energy absorbing element and the top end. The casing defines an electrode aperture in the bottom end shaped to accept the threaded male end of the carbon based electrode.

### BACKGROUND OF THE INVENTION

1. Field of the Invention

The present invention relates generally to the movement of electrodes used in the processing of materials. This invention finds particular application in conjunction with the transportation of carbon based electrodes used to transmit energy used to process metal in metallurgical vessels, including electric arc furnace systems. More particularly, but without limitation, this invention relates to the transportation and holding of graphite electrodes on a threaded male end of the electrode before, during, and after the metal processing procedure.

2. Discussion of the Art

It will be appreciated by those skilled in the art that metallurgical vessels are used in the processing of molten materials to house the molten material during the heating step of the processing. These metallurgical vessels can process such molten materials as steel and slag. Carbon based electrodes are used to transmit the energy to the materials housed within the metallurgical vessels. These conventional metallurgical vessels include cooling systems used to regulate the temperature of the metallurgical vessels. For example, furnace systems of the types disclosed in U.S. Pat. Nos. 4,715,042, 4,813,055, 4,815,096 and 4,849,987 are types of these conventional metallurgical vessels.

Graphites electrodes are one type of carbon based material used to comprise the energy transferring electrodes used in metallurgical vessels. Graphite electrodes are used in the steel industry to melt the metals and other ingredients used to form steel in electrothermal furnaces. The heat needed to melt metals is generated by passing current through one or a plurality of electrodes, usually three, and forming an arc between the electrodes and the metal. Electrical currents in excess of 100,000 amperes are often used. The resulting high temperature melts the metals and other ingredients. Generally, the electrodes used in steel furnaces each consist of electrode columns, that is, a series of individual electrodes joined to form a single column. In this way, as electrodes are depleted during the thermal process, replacement electrodes can be joined to the column to maintain the length of the column extending into the furnace.

Conventionally, electrodes are joined into columns via a pin (sometimes referred to as a nipple) that functions to join the ends of adjoining electrodes. Typically, the pin takes the form of opposed male threaded sections or tangs, with at least one end of the electrodes comprising female threaded sections capable of mating with the male threaded section of the pin. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint.

Alternatively, the electrodes are formed with a male threaded protrusion or tang machined into one end and a female threaded socket machined into the other end, such that the electrodes can be joined by threading the male tang of one electrode into the female socket of a second electrode, and thus form an electrode column. The joined ends of two adjoining electrodes in such an embodiment is referred to in the art as a male-female joint.

Given the extreme thermal stress that the electrode and the joint (and indeed the electrode column as a whole) undergoes, mechanical/thermal factors such as strength, thermal expansion, and crack resistance must be carefully balanced to avoid damage or destruction of the electrode column or individual electrodes. For instance, longitudinal (i.e., along the length of the electrode/electrode column) thermal expansion of the electrodes, especially at a rate different than that of the pin, can force the joint apart, reducing effectiveness of the electrode column in conducting the electrical current. A certain amount of transverse (i.e., across the diameter of the electrode/electrode column) thermal expansion of the pin in excess of that of the electrode may be desirable to form a firm connection between pin and electrode; however, if the transverse thermal expansion of the pin greatly exceeds that of the electrode, damage to the electrode or separation of the joint may result. Again, this can result in reduced effectiveness of the electrode column, or even destruction of the column if the damage is so severe that the electrode column fails at the joint section. Thus, control of the thermal expansion of an electrode, in both the longitudinal and transverse directions, is of paramount importance.

Correspondingly, the transfer and positioning of these graphite electrodes during the metallurgical processes is also important. This is because any damage experienced by the electrodes in their handling, movement, and positioning before, during, and after a given metallurgical process can also result in reduced effectiveness, and/or destruction, of an electrode column.

Conventionally, the electric arc furnace industry uses what is known in the art as a “Lift Plug” to transport the electrodes. The Lift Plug is inserted into the female end of the electrode, and normally threaded into position. This lift plug has several drawbacks. For example, additional support for the electrode is normally required in order to balance the electrode on the Lift Plug.

Additionally, the use of a crane in the movement of carbon based electrodes can put unwanted stresses and strains upon the electrodes themselves. This is especially true to the ends of the electrodes to which the crane is connected to. As a result, weak points in the electrodes can result which can cause a breakdown in the usefulness of the electrode, a shortened lifespan of the electrode, and an overall waste of the electrode in the metal processing procedure.

Additionally, most conventional lifting devices that are used to lift and/or transport carbon based electrodes do not comprise materials that can withstand the stress and/or temperature associated with the metal processing procedures. As such, these conventional lifting apparatuses must be removed before the metal is processed. As a result there is waste in assembly and disassembly time during the electric arc furnace procedures as well as the additional labor and/or equipment costs associated with such conventional lifting apparatuses in this industry.

What is needed, then, is a transport apparatus and method for transporting carbon based electrodes used to transmit energy in the processing of metal in metallurgical vessels. This needed transport apparatus and method for transporting can preferably include biasing elements positioned to absorb kinetic energy created by the movement of the electrodes. This needed transport apparatus and method for transporting can preferably be comprised of materials that allow substantially continued attachment to electrodes in and around metallurgical vessels, including electric arc furnace systems. This transport apparatus and method for transporting is currently lacking in the art.

### SUMMARY OF THE INVENTION

Included herein is a lifting apparatus for transporting a carbon based electrode wherein the electrode includes a threaded male end. The apparatus comprises a casing having a top end and a bottom end, a top plate operatively attached to the top end, at least one biasing element positioned between the top plate and the top end, and an attachment element operatively engaging the biasing element and the top end. The casing defines an electrode aperture in the bottom end shaped to accept the threaded male end of the carbon based electrode.

In a preferred embodiment the casing is internally tapered from the bottom end to the top end such that the bottom end has a larger diameter than the top end. The casing further includes a length and a threaded internal surface substantially spanning the length. Preferably the threaded internal surface is composed of a carbon based material substantially matching the material of the carbon based electrode. Additionally the threaded internal surface mates with the threaded male end of the electrode to secure the lifting apparatus to the electrode.

The casing further includes a cross-sectional shape that is substantially circular when the cross-sectional shape is substantially perpendicular to the length. The casing is substantially cylindrically shaped and a plurality of fasteners attach various features of the lifting apparatus together, including the attachment element, the top end, the top plate, and the at least one biasing element.

The attachment element includes a base plate positioned between the biasing element and the top end, and a gripping element extending from the base plate opposite the bottom end. Preferably the biasing element is at least one spring such that the spring engages the base plate and the top plate.

The casing further includes an attachment aperture defined in the top end and shaped to accept the carbon based electrode. A cover can be positioned extending from the top end and enclosing the attachment aperture opposite the bottom end, such that the cover is positioned to restrict the movement of the carbon based electrode within the casing.

Also included is a lifting apparatus for transporting a graphite electrode having a threaded male end. The apparatus comprises an electrode socket including a lifting end and an electrode end. A handle operatively engages the lifting end and at least one energy dampening element is positioned between the handle and the lifting end. The electrode socket defines an electrode opening in the electrode end wherein the electrode opening includes a plurality of graphite electrode threads shaped to securely engage the threaded male end of the graphite electrode in the electrode opening. The at least one energy dampening element dampens the transfer of kinetic energy between the handle and the electrode socket.

In a preferred embodiment this lifting apparatus further includes a top plate positioned between the electrode socket and the handle wherein the top plate is fixed relative to the electrode socket and is positioned between the lifting end and the handle. The at least one energy dampening element can dampen the movement of the handle relative to the top plate. This can be accomplished by the attachment of the handle such that the energy dampening element is between the top plate and the handle. Additionally, the energy dampening element can dampen the movement of the handle relative to the electrode socket and the top plate.

Also included is a method of lifting a carbon based electrode having a threaded male end. The method comprises providing a lifting apparatus having internal threads and attaching internal threads of the lifting device to the threads of the threaded male end. The method includes lifting the carbon based electrode by the lifting apparatus and passing energy through the carbon based electrode without removing the lifting apparatus. Preferably the method further includes again lifting the carbon based electrode by the lifting apparatus. Additionally, the method can include using an energy absorption element attached to the lifting apparatus to protect the carbon based electrode during the lifting steps.

Also included is a method of lifting a carbon based electrode having a threaded male end wherein the method comprises providing a lifting apparatus having internal threads and attaching the internal threads of the lifting device to the threads of the male end. The method includes moving the carbon based electrode by a lifting apparatus and using the lifting apparatus to absorb kinetic energy produced in the movement of the carbon based electrode.

Preferably this method further includes using an energy absorbing element attached to the lifting apparatus to absorb the kinetic energy and passing energy through the carbon based electrode without removing the lifting apparatus.

It is therefore a general object of the present invention to provide a lifting apparatus for moving carbon based electrodes.

Another object of the present invention is to provide a lifting apparatus for carbon based electrodes that does not need to be removed during the processing of metal as performed by the electrode.

Still another object of the present invention is to provide a lifting apparatus that absorbs kinetic energy produced during the movement of carbon based electrodes.

Yet still another object of the present invention is to provide a lifting apparatus for carbon based electrodes that facilitates protection of the electrodes during movement of the electrodes.

Yet still another object of the present invention is to provide a lifting apparatus for carbon based electrodes that includes a carbon based insert to engage the electrodes.

Another object of the present invention is to provide an improved method for moving carbon based electrodes.

Still another object of the present invention is to provide an improved method for absorbing kinetic energy during the movement of carbon based electrodes.

Other and further objects, features and advantages of the present invention will be readily apparent to those skilled in the art upon reading of the following disclosure when taken in conjunction with the accompanying drawings.

### BRIEF DESCRIPTION OF THE DRAWINGS

FIG. 1 is a perspective view showing an embodiment of a lifting apparatus made in accordance with the current disclosure positioned on a carbon based electrode.

FIG. 2 is a side view of an embodiment of a lifting apparatus made in accordance with the current disclosure attached to a carbon based electrode. FIG. 2 shows partial phantom lines for the lifting apparatus and engagement between the electrode and the lifting apparatus.

FIG. 3 shows a side view of an embodiment of a lifting apparatus made in accordance with the current disclosure. FIG. 3 shows the lifting apparatus in the ready, or non-compressed, state.

FIG. 4 shows a side view similar to FIG. 3. FIG. 4 shows the lifting apparatus in an energy absorption state wherein the handle has been moved relative to the casing.

FIG. 5 is a perspective view showing an example of the attachment between a handle and casing made in accordance with the current disclosure. FIG. 5 shows an example of internal graphite threads within the casing used to engage the carbon based electrode.

FIG. 6 is a side perspective view of an alternate embodiment of a lifting apparatus made in accordance with the current disclosure.

### DETAILED DESCRIPTION OF THE PREFERRED EMBODIMENT

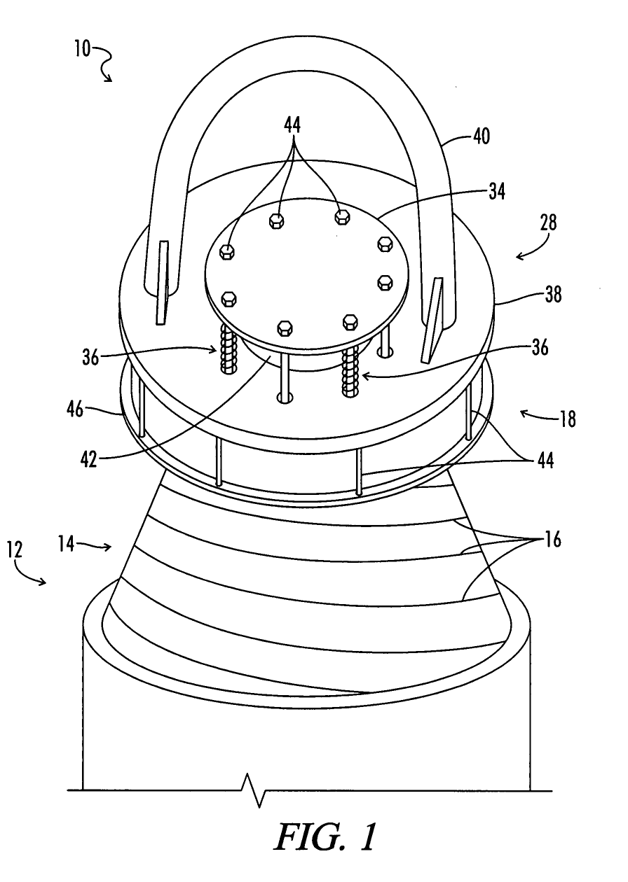

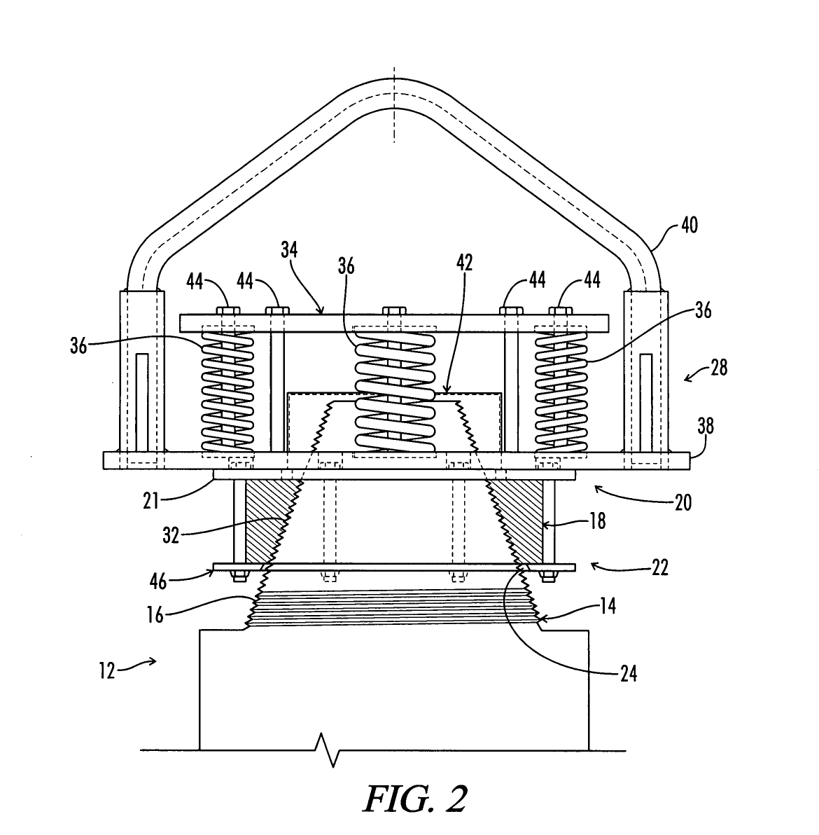

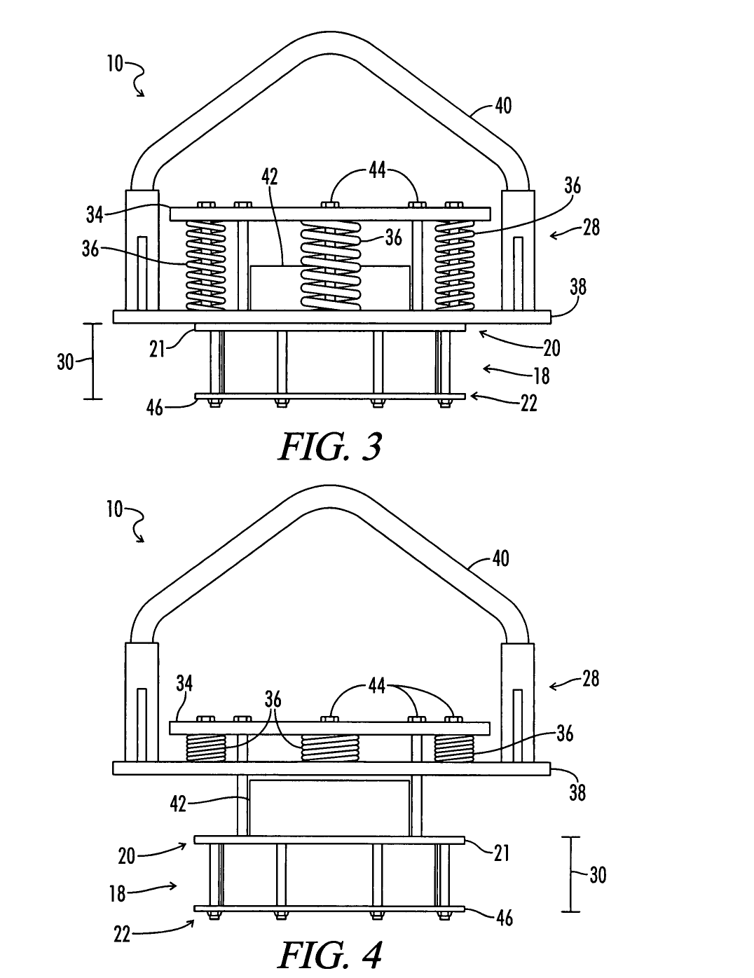

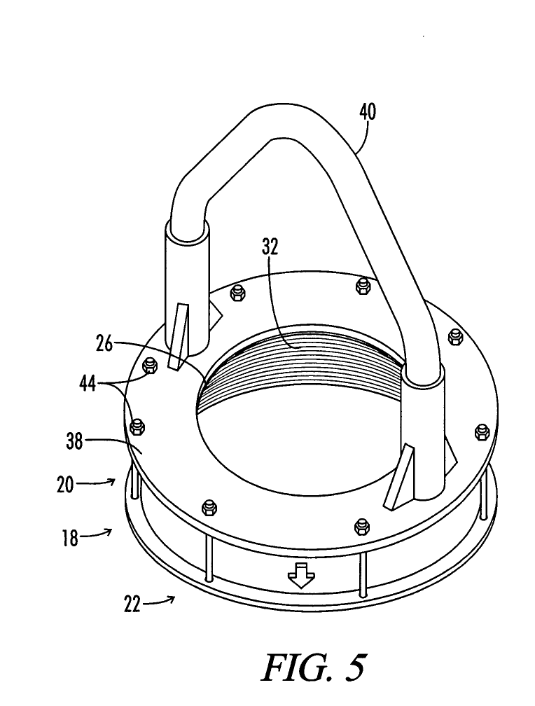

Referring generally now to FIGS. 1-5, a lifting apparatus is shown and generally designated by the numeral 10. The lifting apparatus 10 is for transporting a carbon based electrode 12, which can be described as a graphite electrode 12. The electrode 12 includes a threaded male end 14 having at least one thread 16.

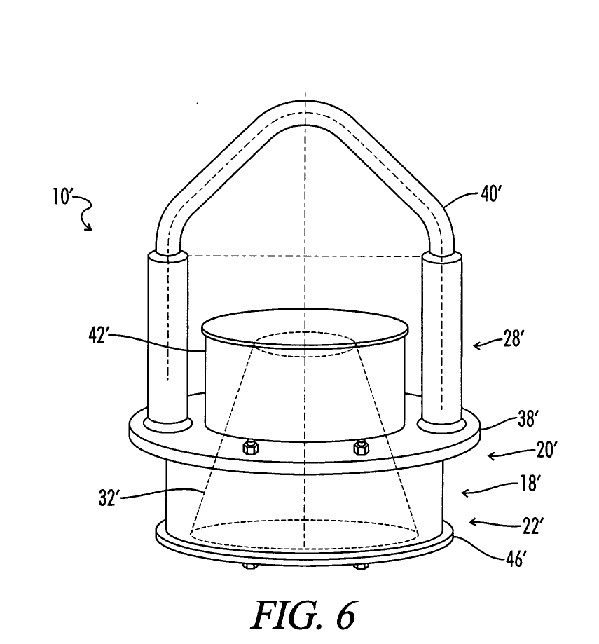

The lifting apparatus 10 includes a casing 18, which can also be described as an electrode socket 18, having a top end 20 and a bottom end 22. The casing 18 defines an electrode aperture 24, which can also be described as an electrode opening 24, and the bottom end 22, which can also be described as an electrode end 22. The electrode aperture 24 is shaped to accept the threaded male end 14 of the electrode 12. A top plate 34 is operatively attached to the top end 20, which can also be described as a lifting end 20, and at least one biasing element 36 is positioned between the top plate 34 and the top end 20. An attachment element 28, which can also be described as a handle 28, operatively engages the biasing element 36, and the top end 20. Alternately, the lifting apparatus 10 can be assembled without the biasing elements 36, as seen in FIG. 6.

Preferably the casing 18 is internally tapered from the bottom end 22 to the top end 20. This internal taper provides at least a partial conical internal shape. The casing 18 further includes a length 30 and a threaded internal surface 32 spanning the length 30. Preferably the threaded internal surface 32 is composed of graphite and mates with the threaded male end 14 of the electrode 12.

The fact that the threaded internal surface 32, which can also be described as electrode threads 32, is composed of graphite allows the lifting apparatus 10 to remain attached to the electrode 12 during the operation of the electrode 12 to process metal. The graphite facilitates the lifting apparatus 10 to withstand the stress and/or temperature associated with the use of the electrode 12 to process metal.

To facilitate the continued attachment of the electrode 12 during the operation of the electrode 12 to process metal, the electrode socket 18 can be comprised of material having a coefficient of thermal expansion substantially matching the coefficient of thermal expansion of the graphite electrode 12. Preferably, the electrode threads 32 can be the portion of the electrode socket 18 that has the desirable coefficient of thermal expansion. For example, the electrode threads 32 can be composed of graphite such that the electrode threads 32 and the graphite electrode 12 have substantially the same coefficient of thermal expansion.

Additionally, in this design, the electrode threads 32 can be removed and replaced as need due to the normal wear and tear on the electrode threads 32. This feature can extend the useful life of the lifting apparatus 10.

The attachment element 28 can further include a base plate 38 positioned between the biasing element 36, which can also be described as an energy absorbing element 36, and the top end 20. A gripping element 40 extends from the base plate 38 opposite the bottom end 22. The gripping element 40 is preferably used to engage a crane or other automated lifting device having sufficient power to lift the electrode 12.

In a more preferred embodiment, the biasing element 36 comprises at least one spring engaging the base plate 38 and the top plate 34. The biasing element 36 can be other items known in the art to alter kinetic energy transfer between two items or absorb kinetic energy between two items.

The casing 18 further includes a top aperture 26, which causally can be described as a top opening 26, defined in the top end 20. The top aperture 26 is shaped to accept the electrode 12. Additionally, a cover 42 can extend from the top end 20 and enclose the top aperture 26 opposite the bottom end 22. The cover 42 can be positioned to restrict movement of the electrode 12 within the casing 18. Additionally, the cover 42 can be used to separate potential carbon based particles that may be produced through the usage of the lifting apparatus 10 and/or the electrode 12 from reducing the effectiveness of the biasing element 36.

Additionally, a plurality of fasteners 44 can be included to attach the various components of the lifting apparatus 10. Fasteners 44 can be attach to the attachment element 28 between the top plate 34 and the top end 20 to provide a location for the engagement of the biasing element 36. Additionally, fasteners 44 can be used to attach the top plate 34 to the top end 20, and more specifically to an intermediate plate 21. Additional fasteners 44 can be used to position the casing 18 between the intermediary plate 21 and a bottom plate 46.

The bottom plate 46 includes the electrode aperture 24 and facilitates engagement between the electrode 12 and the threaded internal surface 32. The intermediary plate 21 includes the top aperture 26 to allow at least a portion of the threaded male end 14 to extend therethrough.

In a preferred embodiment the attachment element 28 is contained between the intermediate plate 21 and the top plate 34. The biasing element 36 is positioned to engage a top plate 34 and the base plate 38 of the attachment element 28. The biasing element 36 preferably presses on the base plate 38 and absorbs the energy of the movement of the base plate 38 as the base plate moves toward the top plate 34. This can also be described as retarding of movement of the attachment element 28 relative to the casing 18.

Also included is a lifting apparatus 10 for transporting a graphite electrode 12 having a threaded male end 14. The apparatus 10 includes an electrode socket 18 including a lifting end 20 and electrode end 22. The electrode socket 18 defines an electrode opening 24 in the electrode end 22 wherein the electrode opening 24 includes a plurality of graphite electrode threads 32 shaped to securely engage the threaded male end 14 of the graphite electrode 12 in the electrode opening 24. A handle 28 operatively engages the lifting end 20 and at least one dampening element 36 is positioned between the handle 28 and the lifting end 20. The dampening element 36 dampens the transfer of kinetic energy between the handle 28 and the electrode socket 18.

Preferably a top plate 34 is operatively positioned between the lifting end 20 and the handle 28. The top plate 34 is preferably fixed to the lifting end 20 and is positioned between a lifting end 20 and the handle 28. The energy dampening element 36 dampens the movement of the handle 28 relative to the top plate 34 in this configuration. Alternately described the dampening element 36 dampens the movement of the handle 28 relative to the lifting end 20.

Thus, although there have been described particular embodiments of the present invention of a new and useful Cushioned Lifting Apparatus and Method of Lifting Carbon Based Electrodes, it is not intended that such references be construed as limitations upon the scope of this invention except as set forth in the following claims.

What is claimed is:

1. A lifting apparatus for transporting a carbon based electrode having a threaded male end, the apparatus comprising:
a casing including a top end and a bottom end, the casing defining an electrode aperture in the bottom end shaped to accept the threaded male end of the carbon based electrode;
a top plate operatively attached to the top end;
at least one biasing element positioned between the top plate and the top end; and
an attachment element operatively engaging the biasing element and the top end.

2. The lifting apparatus of claim 1, wherein the casing is internally tapered from the bottom end to the top end.

3. The lifting apparatus of claim 2, the casing further including a length and a threaded internal surface substantially spanning the length, the threaded internal surface composed of carbon.

4. The lifting apparatus of claim 3, wherein the threaded internal surface mates with the threaded male end of the electrode.

5. The lifting apparatus of claim 1, wherein the attachment element includes:
a base plate positioned between the biasing element and the top end; and
a gripping element extending from the base plate opposite the bottom end.

6. The lifting apparatus of claim 5, wherein the biasing element is at least one spring engaging the base plate and the top plate.

7. The lifting apparatus of claim 1, wherein the biasing element retards the movement of the attachment element relative to the casing.

8. The lifting apparatus of claim 1, the casing further including a top aperture defined in the top end and shaped to accept the carbon based electrode.

9. The lifting apparatus of claim 8, further including a cover extending from the top end and enclosing the top aperture opposite the bottom end.

10. The lifting apparatus of claim 9, wherein the cover is positioned to restrict the movement of the carbon based electrode within the casing.

11. The lifting apparatus of claim 1, further including a plurality of fasteners attaching the attachment element, the top end, the top plate, and the at least one biasing element.

12. The lifting apparatus of claim 1, wherein the biasing element reduces the transfer of kinetic energy from the attachment element relative to the casing.

13. A lifting apparatus for transporting a graphite electrode having a threaded male end, the apparatus comprising:
an electrode socket including an lifting end and an electrode end, the electrode socket defining an electrode opening in the electrode end, wherein the electrode opening includes a plurality of graphite electrode threads shaped to securely engage the threaded male end of the graphite electrode in the electrode opening;
a handle operatively engaging the lifting end; and
at least one energy dampening element positioned between the handle and the lifting end, wherein the at least one energy dampening element dampens the transfer of kinetic energy between the handle and the electrode socket.

14. The lifting apparatus of claim 13, further including a top plate operatively positioned between the lifting end and the handle.

15. The lifting apparatus of claim 14, wherein the top plate is fixed relative to the lifting end and is positioned between the lifting end and the handle.

16. The lifting apparatus of claim 15, wherein the at least one energy dampening element dampens the movement of the handle relative to the top plate.

17. The lifting apparatus of claim 13, wherein the at least one energy dampening element dampens the movement of the handle relative to the lifting end.

18. A method of lifting a carbon based electrode having a threaded male end, the method comprising:
a) providing a lifting apparatus having internal threads;
b) attaching the internal threads of the lifting device to the threads of the threaded male end;
c) lifting the carbon based electrode by the lifting apparatus;
d) passing energy through the carbon based electrode without removing the lifting apparatus.

19. The method of claim 18, further including using an energy absorption element attached to the lifting apparatus to protect the carbon based electrode during the lifting step c).

20. The method of claim 18, further including substantially matching the coefficient of thermal expansion of the internal threads to the coefficient of thermal expansion of the carbon based electrode.

21. A method of lifting a carbon based electrode having a threaded male end, the method comprising:
a) providing a lifting apparatus having internal threads;
b) attaching the internal threads of the lifting device to the threads of the threaded male end;
c) moving the carbon based electrode by the lifting apparatus; and
d) using the lifting apparatus to absorb kinetic energy produced in step c).

22. The method of claim 21, wherein step d) further includes using an energy absorption element attached to the lifting apparatus to absorb kinetic energy.

23. The method of claim 21, further including step e) passing energy through the carbon based electrode without removing the lifting apparatus.

24. The method of claim 21, further including substantially matching the coefficient of thermal expansion of the internal threads to the coefficient of thermal expansion of the carbon based electrode.

25. A lifting apparatus for transporting a graphite electrode having a threaded male end and a coefficient of thermal expansion, the apparatus comprising:
an electrode socket including an lifting end and an electrode end, the electrode socket defining an electrode opening in the electrode end, wherein the electrode opening includes a plurality of electrode threads shaped to securely engage the threaded male end of the graphite electrode in the electrode opening; and
a handle operatively engaging the lifting end.

26. The lifting apparatus of claim 25, wherein the electrode socket is comprised of material having a coefficient of thermal expansion substantially matching the coefficient of thermal expansion of the graphite electrode.

27. The lifting apparatus of claim 26, wherein the electrode socket is comprised of graphite.

28. The lifting apparatus of claim 26, further including:
a top plate operatively positioned between the lifting end and the handle
at least one energy dampening element positioned between the handle and the lifting end, wherein the at least one energy dampening element dampens the transfer of kinetic energy between the handle and the electrode socket.

29. The lifting apparatus of claim 28, wherein the at least one energy dampening element dampens the movement of the handle relative to the top plate and the lifting end.
